(19) United States
(12) Patent Application Publication
(10) Pub. No.: US 2017/0280309 A1
(43) Pub. Date: Sep. 28, 2017

(54) METHOD AND TERMINAL FOR CALLING APPLICATION

(71) Applicants: Le Holdings (Beijing) Co., Ltd., Beijing (CN); Lemobile Information Technology (Beijing) Co., Ltd., Beijing (CN)

(72) Inventor: Yuchen Guo, Beijing (CN)

(21) Appl. No.: 15/351,117

(22) Filed: Nov. 14, 2016

Related U.S. Application Data
(63) Continuation of application No. PCT/CN2016/096937, filed on Aug. 26, 2016.

(30) Foreign Application Priority Data
Mar. 28, 2016 (CN) 2016101834635

(51) Int. Cl. H04W 4/20; H04L 29/08

(52) U.S. Cl. CPC H04W 4/20; H04L 67/16

(57) ABSTRACT

Disclosed are a method and terminal for calling application. An embodiment of the present disclosure provides a method for calling application, executed by a terminal, the terminal including a first application and a second application, and the first application is in a using status, wherein the first application and the second application have an association relation, the method including: acquiring, by the terminal, operation information to the first application of a user; and calling the second application, by the terminal, based on the association relation according to the operation information. Through associating the first application with the second application in the embodiment of the present disclosure, when the user wants to open the second application, operation on the first application allows direct calling of the second application, thus saving time for the user to find the second application and improving the operation efficiency of the user.

### CROSS REFERENCE TO RELATED APPLICATIONS

This application is a continuation of International Application No. PCT/CN2016/096937, with an international filing date of filed Aug. 26, 2016, which is based upon and claims priority to Chinese Patent Application No. 2016101834635, filed on Mar. 28, 2016, the entire contents of which are incorporated herein by reference.

### TECHNICAL FIELD

The present disclosure relates generally to the technical field of communications, including but not limited to a method and terminal for calling application.

### BACKGROUND

In daily use of a mobile phone or computer, while using an application, a user often opens another application; or after finishing using an application, the user opens another application; or the user needs to alternately open a plurality of applications.

During implementation of the present disclosure, the inventor discovers at least the following problem in the prior art: in the case of too many applications installed in a mobile phone or computer, when a user opens another application, time may be wasted for finding it, and the operation efficiency is reduced.

### SUMMARY

In view of this, the present disclosure provides a method and terminal for calling application to solve the problem in the prior art that the operation efficiency is reduced when a user opens another application.

In order to achieve the purpose of the present disclosure mentioned above, in one aspect, an embodiment of the present disclosure provides a method for calling application, executed by a terminal, the terminal includes a first application and a second application, the first application is in a using status, where, the first application and the second application have an association relation, and the method including: acquiring, by the terminal, an operation information to the first application of a user; and calling the second application, by the terminal, based on the association relation according to the operation information.

To achieve the above invention object, in a further aspect, an embodiment of the present disclosure further provides a terminal, including at least one processor; and a memory communicably connected with the at least one processor for storing instructions executable by the at least one processor, wherein execution of the instructions by the at least one processor causes the at least one processor to: acquire an operation information to a first application of a user; and call a second application based on the association relation according to the operation information.

To achieve the above invention object, in a further aspect, an embodiment of the present disclosure further provides a non-transitory computer-readable storage medium storing executable instructions that, when executed by an electronic device with a touch-sensitive display, cause the electronic device to: acquire an operation information to a first application of a user; and call a second application based on the association relation according to the operation information.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow diagram illustrating a method for calling application in accordance with some embodiments;

FIG. 2 is a block diagram illustrating a terminal in accordance with some embodiments; and

FIG. 3 is a block diagram illustrating the hardware structure of the terminal for executing the method for calling application in accordance with some embodiments.

### DETAILED DESCRIPTION

One or more embodiments of the present disclosure are described below in conjunction with the accompanying drawings, and it should be understood that the one or more embodiments described here are only used for illustrating and interpreting the present disclosure rather than limiting the present disclosure.

It should be apparent that the embodiments described are merely part, instead of all, of the embodiments of the present disclosure. All other embodiments obtained by those of ordinary skill in the art without creative effort, based on the embodiments of the present disclosure, fall into the protection scope of the present disclosure.

Terms as used in the embodiments of the present disclosure are only used for describing the specific embodiments, and are not intended to limit the present disclosure. Singular words “a”, “said” and “the” as used in the embodiments of the present disclosure and the appended claims are also intended to cover plural forms, unless otherwise indicated clearly in the context.

It will be appreciated that although the terms first and second may be used for describing a first application and a second application in the embodiments of the present disclosure, the first application and the second application should not be limited to such terms. The terms are only used for distinguishing the first application and the second application from each other. For example, without departing from the scope of the embodiments of the present disclosure, the first application may also be called second application, and similarly, the second application may also be call first application. Depending on the context, the word “if” as used here may be interpreted as “at the time of . . . ” or “when . . . ” or “in response to determining” or “in response to detecting”. Similarly, depending on the context, the phrase “if determining” or “if detecting (a stated condition or event)” may be interpreted as “when determining” or “in response to determining” or “when detecting (a stated condition or event)” or “in response to detecting (a stated condition or event)”.

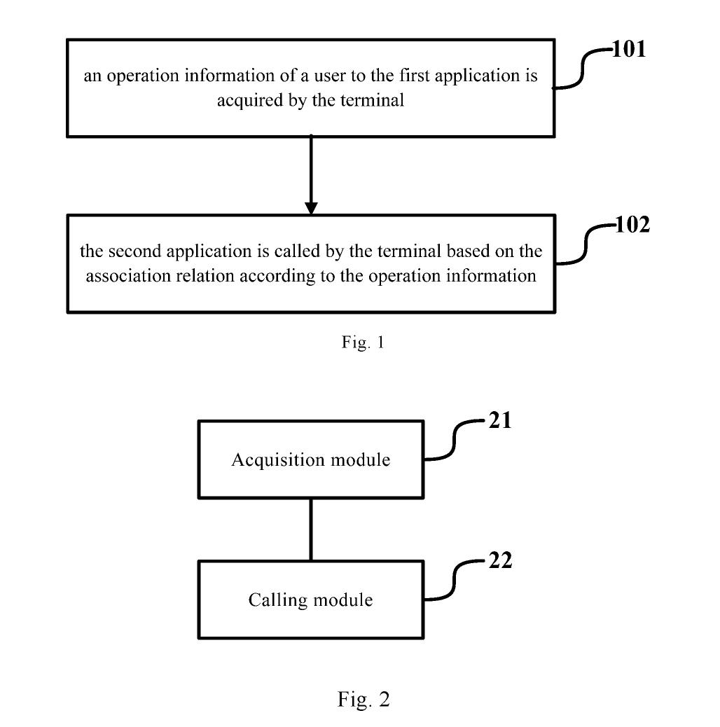

In order to solve the problem in the prior art that the operation efficiency is reduced when a user opens another application, embodiment 1 of the present disclosure provides a method for calling application, specifically as shown in FIG. 1, a terminal including a first application and a second application, the first application is in a using status, wherein the first application and the second application have an association relation, the method including steps 101 to step 102.

Step 101, an operation information of a user to the first application is acquired by the terminal.

Wherein, the operation information is operation information for calling the second application.

It should be noted that the terminal involved in the embodiments of the present disclosure may include, but not limited to, a personal computer (PC), a personal digital assistant (PDA), a wireless handheld device, a tablet computer, a mobile phone, an MP3 player, an MP4 player, and the like, and the terminal at least include two applications.

Specifically, the first application is in a using status indicates that the user is currently using the first application or the user is currently on an operation interface of the first application; and the first application and the second application having an association relation are set by the user according to his requirement to ensure that the second application may be opened quickly via the association relation, and the user may open any second application in the terminal through the first application via setting the association relation.

Step 102, the second application is called by the terminal based on the association relation according to the operation information.

Specifically, through the operation on the first application, the user may directly open the second application with the association relation, thus avoiding wasted time for finding the second application when opening the second application.

At least one second application is associated with the first application in one association relation.

Specifically, the user may set a plurality of association relations in the first application, and at least one second application is associated with the first application in each association relation. For example, there are three association relations in the first application, and each of the three association relations corresponds to at least one second application; and further, the terminal may open at least one second application via one association relation, and the terminal may open different second applications via different association relations.

When a plurality of second applications are associated with the first application in one association relation, the number and/or type of the second applications associated with the first application are different in different association relations.

Specifically, the user may open a plurality of second applications via one association relation, the numbers of the second applications opened via different association relations may be different or same, there may be a same second application in different association relations, for example, there are three association relations in the first application, in which second applications included in a first association relation are second application 1, second application 2 and second application 3; second applications included in a second association relation are second application 1 and second application 3; and second applications included in a third association relation are second application 1, second application 2 and second application 5, wherein the number of one type of association relation is one; that is, when second applications included in one association relation are second application 1, second application 2 and second application 3, second applications included in another association relation should not be only second application 1, second application 2 and second application 3.

Calling the second application, by the terminal, based on the association relation according to the operation information includes: calling the corresponding second application, by the terminal, based on the association relation according to the operation information; wherein the called second application is the second application with the corresponding number and type.

Specifically, the user may call a plurality of second applications simultaneously, for example, when second applications included in one association relation are second application 1, second application 2 and second application 3, the second applications called by the terminal simultaneously are second application 1, second application 2 and second application 3.

The second application may be directly called based on the association relation in the embodiment of the present disclosure. By associating the first application with the second application in the embodiment of the present disclosure, when the user wants to open the second application, operation on the first application allows direct calling of the second application, thus saving time for the user to find the second application and improving the operation efficiency of the user.

Embodiment 2 of the present disclosure further provides a terminal embodiment for implementing the steps and method in the method embodiment described above, as shown in FIG. 2 which is a block diagram of configuration of a terminal provided by the embodiment of the present disclosure, the terminal including a first application and a second application, the first application being in use, wherein the first application and the second application have an association relation, the terminal including: an acquisition module 21 and a calling module 22.

The acquisition model 21 is configured to acquire an operation information to the first application from a user.

The calling module 22 is configured to call the second application based on the association relation according to the operation information.

The operation information is an operation information for calling the second application.

At least one second application is associated with the first application in one association relation.

When a plurality of second applications are associated with the first application in one association relation, the number and/or type of the second applications associated with the first application are different in different association relations.

The calling module is specifically configured to: call the corresponding second application based on the association relation according to the operation information; wherein the called second application is the second application with the corresponding number and type.

As the units in the embodiment of the present disclosure can carry out the method shown in FIG. 1, for the part not described in detail in the embodiment of the present disclosure, reference may be made to relevant description for FIG. 1.

The second application may be directly called based on the association relation in the embodiment of the present disclosure. By associating the first application with the second application in the embodiment of the present disclosure, when the user wants to open the second application, operation on the first application allows direct calling of the second application, thus saving time for the user to find the second application and improving the operation efficiency of the user.

The present embodiment of the present disclosure provides a non-transitory computer-readable storage medium storing executable instructions, and the computer executable instructions may execute the processing method in the case of any method embodiment mentioned above.

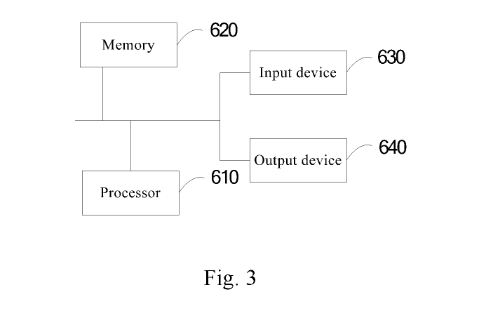

FIG. 3 is a schematic diagram of a hardware structure of the terminal for executing a method for calling application provided by some embodiments of the present disclosure, and as shown in FIG. 3, the terminal includes:

One or more processors 610 and a memory 620. One processor is used as an example in FIG. 3. The terminal may further include: an input device 630 and an output device 640.

The processor(s) 610, the memory 620, the input device 630 and the output device 640 may be connected via a bus or by other means. Connection via a bus is used as an example in FIG. 3.

The memory 620, as a non-transitory computer-readable storage medium storing, may be configured to store non-transitory software programs, non-transitory computer executable programs and modules. The processor 610 runs the non-transitory software programs, instructions and modules stored in the memory 620 to execute various function applications of the electronic device and data processing, i.e. implementing the processing method in the method embodiment mentioned above. The electronic device includes terminal, server and the like.

The memory 620 may include a program storing area and a data storing area, wherein the program storing area may store an operating system, and an application program required for at least one function, and the data storing area may store data and the like. In addition, the memory 620 may include a high-speed random access memory, and may also include a non-transitory memory, such as at least one disk storage device, flash memory device or other non-transitory solid-state memory device. In some embodiment, the memory 620 optionally includes memories arranged remotely relative to the processor 610, and these remote memories may be connected to a processing device via network connection. Examples of the network described above include, but not limited to, Internet, Intranet, local area networks, mobile communication networks and combinations thereof.

The input device 630 may receive input numerical or character information and produce a signal input. The output device 640 may include a display device such as a display screen.

The one or more modules are stored in the memory 620, and when executed by the one or more processors 610, execute: acquiring an operation information to the first application of a user; and calling the second application based on the association relation according to the operation information.

In a possible implementation, the operation information is operation information for calling the second application.

In a possible implementation, at least one second application is associated with the first application in one association relation.

In a possible implementation, when a plurality of second applications are associated with the first application in one association relation, the number and/or type of the second applications associated with the first application are different in different association relations.

In a possible implementation, calling the second application based on the association relation according to the operation information includes: calling the corresponding second application based on the association relation according to the operation information; wherein the called second application is the second application with the corresponding number and type.

The product described above may execute the method provided by the embodiment of the present disclosure, and has the corresponding functional modules for executing the method and beneficial effects. For technical details not fully described in the present embodiment, reference can be made to the method provided by the embodiment of the present disclosure.

The terminal of the embodiment of the present disclosure exists in various forms, including but not limited to:

Mobile communication devices: such devices are featured by a mobile communication function and has a main object of providing voice and data communication; such terminals include: mobile phones (e.g. iPhone), multimedia phones, functional phones, and low-end phones.

Ultra-mobile personal computer devices: such devices belong to the category of personal computers, have computing and processing functions, and generally also have mobile surfing features; such terminals include: PDAs, MIDs and UMPCs, such as iPad.

Portable amusement devices: such devices may display and play multimedia contents; such devices include: audio and video players (e.g. iPod), handheld game players, electronic book readers, as well as intelligent toys and portable vehicle navigation devices.

Servers: which are devices providing computing services, such a server is composed of a processor, a hard disk, a memory, a system bus and the like; the server is similar to a general computer architecture, and however, as required to provide a highly reliable service, has a high requirement on the handling capacity, stability, reliability, security, expansibilty, manageability and the like.

Other devices with data interactive functions.

The apparatus embodiment described above is merely schematic, wherein units described as separate components may be or may be not physically separate, and components shown as units may be or may be not physical units, i.e. may be located in one place, and may also be distributed on multiple network units. Some or all of the modules may be selected according to actual requirements to achieve the object of the solution of the present embodiment.

From the above description of implementations, those skilled in the art may clearly know that various implementations may be achieved by virtue of software and a general-purpose hardware platform, and of course, may also be achieved by hardware. With this understanding, the solutions described above, in essence or for the part contributing to the relevant art, may be embodied in the form of a software product, and the computer software product may be stored in a computer readable storage medium, such as an ROM/RAM, a magnetic disk, an optical disc or the like, and includes a number of instructions for causing a computer device (which may be a personal computer, a server, a network device or the like) to execute the method described in the embodiments or in parts of the embodiments.

Finally, it should be noted that the above embodiments are only used for illustrating rather than limiting the technical solutions of the present disclosure. Although the present disclosure is described in detail with reference to the foregoing embodiments, those of ordinary skill in the art should understand that they still can make modifications to the technical solutions disclosed in the foregoing embodiments or make equivalent substitutions to part of technical features thereof; and such modifications or substitutions should not cause the essence of the corresponding technical solutions to depart from the spirit and scope of the technical solutions of the embodiments of the present disclosure.

What is claimed is:

1. A method for calling application, wherein executed by a terminal, the terminal comprises a first application and a second application, the first application is in a using status, wherein the first application and the second application have an association relation, the said method comprising:
acquiring, by the terminal, an operation information to the first application of a user; and
calling the second application, by the terminal, based on the association relation according to the operation information.

2. The method according to claim 1, wherein the operation information is an operation information for calling the second application.

3. The method according to claim 1, wherein at least one second application is associated with the first application in one association relation.

4. The method according to claim 3, wherein when a plurality of the second applications are associated with the first application in one association relation, the number and/or type of the second applications associated with the first application are different in different association relations.

5. The method according to claim 4, wherein calling the second application, by the terminal, based on the association relation according to the operation information comprises:
calling the corresponding second application, by the terminal, based on the association relation according to the operation information;
wherein the called second application is the second application with the corresponding number and type.

6. A terminal, comprising:
at least one processor; and
a memory communicably connected with the at least one processor for storing instructions executable by the at least one processor, wherein execution of the instructions by the at least one processor causes the at least one processor to:
acquire an operation information to the first application of a user; and
call the second application based on the association relation according to the operation information.

7. The terminal according to claim 6, wherein the operation information is an operation information for calling the second application.

8. The terminal according to claim 6, wherein at least one second application is associated with the first application in one association relation.

9. The terminal according to claim 8, wherein when a plurality of the second applications are associated with the first application in one association relation, the number and/or type of the second applications associated with the first application are different in different association relations.

10. The terminal according to claim 9, wherein calling the second application based on the association relation according to the operation information comprises:
calling the corresponding second application based on the association relation according to the operation information;
wherein the called second application is the second application with the corresponding number and type.

11. A non-transitory computer-readable storage medium storing executable instructions that, when executed by an electronic device, cause the electronic device to:
acquire an operation information to a first application of a user; and
call a second application based on an association relation according to the operation information.

12. The non-transient computer readable storage medium according to claim 11, wherein the operation information is operation information for calling the second application.

13. The non-transient computer readable storage medium according to claim 11, wherein at least one second application is associated with the first application in one association relation.

14. The non-transient computer readable storage medium according to claim 13, wherein when a plurality of the second applications are associated with the first application in one association relation, the number and/or type of the second applications associated with the first application are different in different association relations.

15. The non-transient computer readable storage medium according to claim 14, wherein calling the second application based on the association relation according to the operation information comprises:
calling the corresponding second application based on the association relation according to the operation information;
wherein the called second application is the second application with the corresponding number and type.
